(19) United States
(12) Patent Application Publication
(10) Pub. No.: US 2021/0223363 A1
(43) Pub. Date: Jul. 22, 2021

(54) OBJECT DETECTION ON A PATH OF TRAVEL AND OBSTACLE DETECTION ON RAILWAY TRACKS USING FREE SPACE INFORMATION

(71) Applicant: Outsight SA, Paris (FR)

(72) Inventor: Raul Bravo Orellana, Paris (FR)

(73) Assignee: Outsight SA, Paris (FR)

(21) Appl. No.: 16/745,169

(22) Filed: Jan. 16, 2020

(51) Int. Cl. G01S 7/48; G06K 9/00; G06K 9/62; G01S 17/42; G01S 17/931; B61L 23/04

(52) U.S. Cl. CPC G01S 7/4802; G06K 9/00805; G06K 9/00201; B61L 23/041; G01S 17/42; G01S 17/931; G06K 9/6202

(57) ABSTRACT

A method and apparatus of performing object detection on a path of travel is described. The invention is also related to obstacle detection on railway tracks. Object detection over irregular surfaces or traveling over know paths is also provided. The invention can be applied to railways for obstacle detection on train tracks with a look-ahead sensor system such as a lidar and/or camera system. The object detection may involve the use of multispectral lidar and material identification as well as artificial intelligence for object identification. A reference map is created during a first pass through a virtual tunnel of travel. A vehicle travelling through the tunnel of travel the vehicle will register with reference map and use differences between scans and the reference map to perform object detection. Responses are performed based on the object detection or object identification.

### FIELD OF THE INVENTION

The present invention relates to object detection on a regular route of a vehicle. More particularly, the present invention relates to performing object detection while going through a path of travel. The present invention can be applied to railways for obstacle detection on train tracks with a look-ahead sensor system such as a lidar and/or camera system.

### BACKGROUND OF THE INVENTION

Automated object detection is an important component to modern vehicle safety and navigation. As a vehicle travels down a path, objects may be detected and appropriate responses taken. The responses may vary on the type of object detected including the size or material, of whether the object is fixed, mobile, hard or soft. Given the various responses that may be required, accurate object detection is highly desirable.

To take advantage of the high quality and low cost digital imaging systems available today, some object detection is performed using 2D image processing. As might be expected, image processing based on 2D images from video feeds do not have distance information. Without distance information, objects are usually detected through visual recognition.

Visual recognition algorithms may use machine learning to detect and identify objects on irregular or uneven surfaces such as train tracks. The identification is performed by trained classifiers, which is the logic that is produced from the artificial intelligence (AI) training process. These trained classifiers are difficult to certify because the internal logic is a “black box” and therefore difficult to validate or characterize.

False positives are another problem with trained classifiers. It is difficult to avoid false positives because the variety of shapes encountered on uneven surfaces, like train tracks, is undefined and essentially unlimited. Additionally, the system performing the identification is usually part of a vehicle that is moving down the path of travel at a reasonably high speed so that the contents of the images are moving. Attempting to identify a large number of objects using images taken while moving leads to many false positives, which reduce the usefulness of AI identification systems for object detection on irregular surfaces.

Many vehicles travel regular and known paths over irregular terrain. A good example of this is a train, which typically travels over tracks placed on crushed stone embankments. Buses may also travel well known paths. Since accurate object identification is so important to automated vehicles, it would be beneficial to take advantage of the fact that certain vehicles travel over know paths when performing object identification in order to increase the overall accuracy.

### SUMMARY OF THE INVENTION

A system and method for performing object detection in a vehicle travelling over a known path is described. In accordance with one embodiment of the invention. the object detection is performed by generating a reference map during a first pass over the path. During a second pass the vehicle is registered at a location within the reference map and a 3D point cloud generated during the second pass is compared with the reference map. Any differences detected during the comparison are used to perform object detection.

The known path may be defined by a “tunnel of travel” in some embodiments. The tunnel of travel is defined as the space having a known height and width over the ground of the known path of travel. In one embodiment of the invention the reference map is created during a first pass through the tunnel of travel by scanning a path as least as wide and as high as the tunnel of travel and recording the detected surfaces into the reference map including the ground level surfaces. The stored surface data preferably includes the locations along the tunnel of travel as well as the time at which the data was last updated.

During exemplary operation, a vehicle travelling through the tunnel of travel will perform its own 3D scan. The scan will typically be focused, or directed, at a location in the tunnel of travel that is ahead of the vehicle's current location in the tunnel of travel. Since the tunnel of travel may not follow a straight line, and the vehicle knows the path of the tunnel of travel, in many cases the vehicle will scan at a location that is not the same as the current direction of travel of the vehicle. For example, if the tunnel of travel curves to the right ahead of the current location of the vehicle then the scan will be performed forward and to the right of the current direction of travel. Alternatively, if the tunnel of travel curves to the left ahead of the current location of the vehicle then the scan will be performed to the left of the current direction of travel. Clearly, the scan may also be directly in front of the vehicle if the tunnel of travel continues in the same direction as the current direction of travel. Curves can also include hard angle turns in some embodiments of the invention. How far ahead along the tunnel of travel the scan is performed may vary with the size and speed of the vehicle, as well as the terrain and environment including level of urbanization, incline and presence of obstructions.

### BRIEF DESCRIPTION OF THE DRAWINGS

FIG. 1 is a block diagram of an object detection and imaging system.

FIG. 2A a side view of a train travelling over train tracks.

FIG. 2B a side view of a train travelling over train tracks with objects in the tunnel of travel.

FIG. 3 an overhead view of a train travelling over train tracks.

FIG. 4 is a flow chart illustrating the steps performed in accordance with some embodiments of the invention.

### DETAILED DESCRIPTION OF THE INVENTION

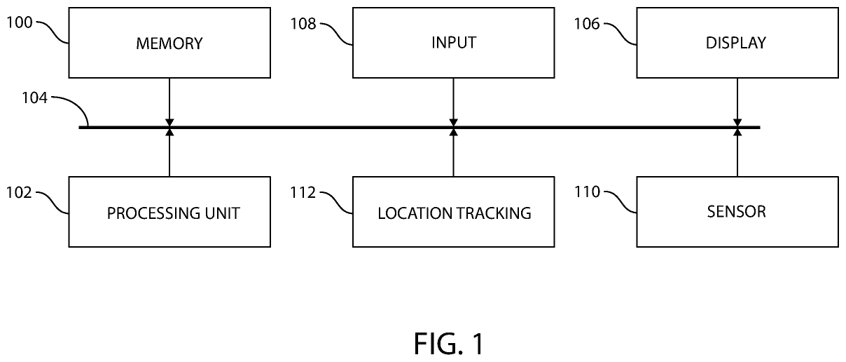

FIG. 1 is a block diagram of an object detection configured in accordance with one embodiment of the invention. The system includes memory 100, processing unit 102, interconnect 104, display 106, input 108 and sensor 110. Memory 100 contains data and instructions that are used by processing unit 102. These data and instruction cause processing unit 102 to receive image data from sensor 110 and display information on display 106. Additionally, processing unit 102 may receive user input from input 108.

In general, the various steps and operations described herein are performed by processing unit 102 which receives instructions stored in memory 100. Processing unit 102 controls the various other blocks in response to the instructions from memory unit 100 as well as in response to data received from other blocks shown FIG. 1.

Memory 100 is typically a combination of semiconductor-based static and dynamic RAM working in conjunction flash-RAM and hard disk drive storage systems, or some subset thereof. Processing unit 102 is preferably a semiconductor-based microprocessor unit. Input 108 may be a keyboard, selection knob, joystick, or touch screen. Display 106 is typically a flat screen display such as an LCD or OLED display. In some embodiments of the invention input 108 and display 106 may be integrated into a single touch-screen display. Interconnect 104 may be a parallel computer bus, USB, SATA, PATA, ethernet or some combination thereof.

Sensor 110 may be various types of scanning devices, including radio frequency, infrared, optical or ultraviolet sensing semiconductor device or component. Sensor 110 may also be a sound sensing device such as a microphone. In various embodiments of the invention the sensors may be time-of-flight 3D scanners or more generally depth-resolved imaging systems such as Lidar. In still other embodiments of the invention, sensor 110 may be a stereoscopic camera system, such as a stereoscopic 3D camera system comprising a 2D camera sensors providing 2D images that can be used to perform geometric transformations to derive 3D information from a set of 2D images. Sensor 110 may generate light, radio frequency signal or sound to enable the detection of the reflection of these signals from object surfaces, or it may use signals naturally present in the environment such as light from outside sources. The described embodiments herein typically use lidar for sensor 110, but sensor 110 should not be limited to lidar.

Alternative embodiments of the invention may place one or more of the components (or portions therefore) shown in FIG. 1 in remote locations. In this configuration the remotely located components would be accessed via network connections. For example, portions of memory 110 may be cloud based storage with topographical information such as 3D point cloud generated during a previous pass or passes, or free space information derived from 3D point cloud data generated during a previous pass or passes or a path of travel determined during a previous pass or passes. The topographical information may also include the location of buildings and other structures that are accessed via the Internet.

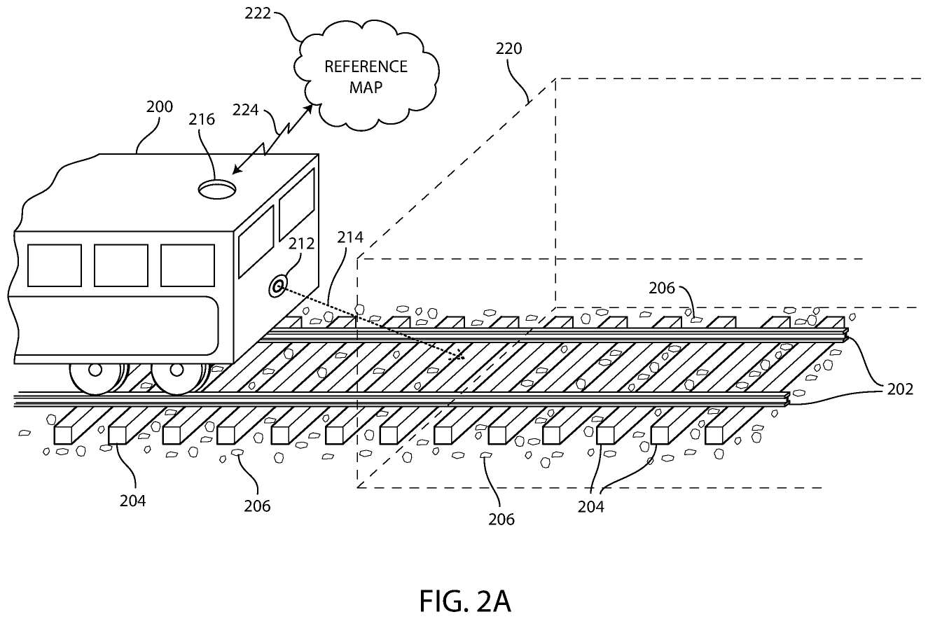

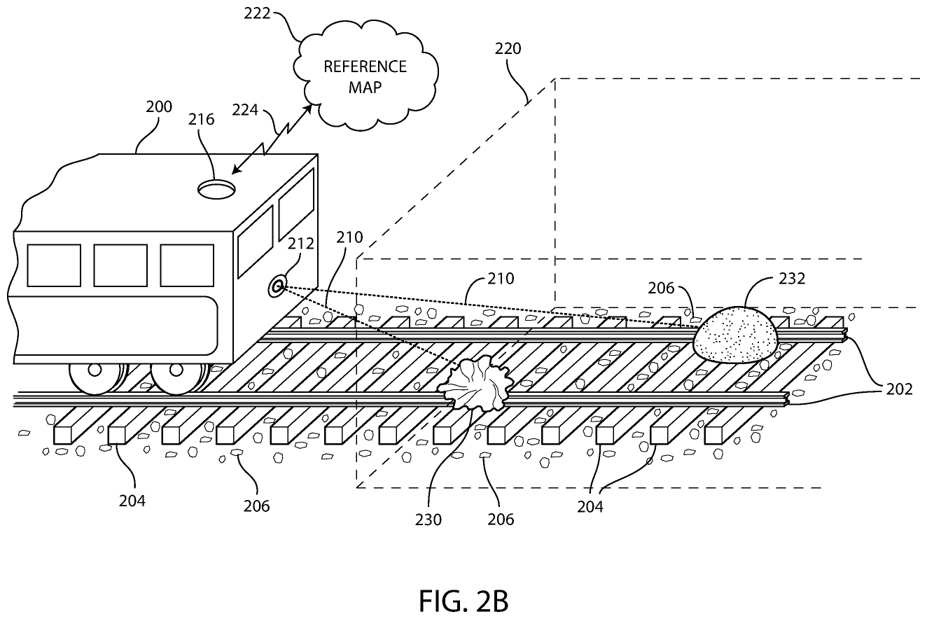

FIG. 2A shows a train and train tracks configured in accordance with one embodiment of the invention. In this embodiment train 200 is travelling over train tracks 202, which are connected via railroad ties 204 which sit atop crushed rock 206. Train tracks 202, crushed rock 206 and railroad ties 204 combine to form a highly irregular surface that makes object detection very difficult. In one embodiment of the invention, the object detection system shown in FIG. 1. is traveling within train 200.

Still referring to FIG. 2, in accordance with one embodiment of the invention a “travel tunnel” 220 is established along a known path of travel over train tracks 202. The travel tunnel 220 is a virtual tunnel established based on a height and width above train tracks 202 and which goes down to the surface comprised of train tracks 202, railroad ties 204 and crushed rock 206, as well as any other surfaces that might be along the path of travel of train 200. Travel tunnel 220 will follow train track 202 as it passes over the terrain including and turns and curves that might exist on the particular route being travelled.

Train 200 also communicates via a wireless interface 216 and wireless link 224 with reference map 222. Reference map 222 may be located in a “cloud” based database. Those skilled in the art will recognize that reference map may also be located in train 200 and that alternative methods for interfacing with reference map 222 may also be used. For example, a wire-based interface may also be used if train 200 is an electrical train that is powered by an overhead electrical line over which communication signals may also be transmitted.

In one embodiment of the invention reference map 222 contains data for all the surface points previously detected within virtual tunnel 220. These surface points may include all the surface points for the irregular surface formed by tracks 202, ties 204 and rocks 206, as well as any surfaces above or to the left or right of the tunnel of travel. This would include buildings, trees or any other objects or structures.

In some embodiments of the invention reference map 222 will also contain free space information. This free space information includes a database or list of previously unoccupied 3D points, or voxels, that may be determined by calculating line-of-sight vectors to surface points. A system and method for performing 3D imaging use free space information is described in co-filed and co-pending U.S. patent application Ser. No. ______ entitled “Single Frame Motion Detection and Three-Dimensional Imaging Using Free Space Information” assigned to the assignee of the present invention and incorporated herein by reference in its entirety.

In an exemplary embodiment of the invention, train 200 begins its scheduled route over train tracks 202 by registering with reference map 220. The registration process generally consists of logging the current location of train 200 and downloading the next section of travel tunnel 220 along which the train will travel on its scheduled route.

As train 200 travels down track 202 along a scheduled route lidar 212 transmits laser pulse 214 to the areas within and around tunnel of travel 220. Laser pulse 214 scans over the area in front of train 200 and the laser reflections are used to determine the surrounding surface areas including the shape of train tracks 202, railroad ties 204 and crushed rock 206. Then train 200 compares the detected surfaces to the surface points for the associated section of travel tunnel 202 with reference database 220.

In accordance with one embodiment of the invention the result of the comparison may yield a set of surface points that do not match the corresponding set of surface points from reference map 220. If new surface points are detected, then object detection is performed using these new surface points. These new surface points may also be thought of as the difference set. This object detection may take into account the shape, size and connectivity (or lack thereof) of these new surface points. Based on the nature of the object detected, various responses can be implemented including issuing warnings, sounding alarms or attempting to stop or slow the train.

FIG. 2B is an illustration of a train travelling over train tracks in accordance with one embodiment of the invention. In this embodiment, the laser pulses from lidar 212 are reflected from bag 230 and stone 232, which are located over tracks 202 within tunnel of travel 220. The object detection system will compare the surface reflections with the reference map 222 for this same location and determine that new 3D surface points have been detected. Object detection will be performed on the new surface points.

In the case of bag 230, the object detection system will note the irregular shape as well as the overall size. The shape and size of the object will be compared against a database and object identification performed. In some embodiments of the invention, object identification may be performed after or even concurrently with object detection. The object identification may incorporate artificial intelligence (AI) techniques. Additionally, in some embodiments of the invention the object detection system will note the level of reflectivity of the surface points. Additionally, when using a multi-spectrum lidar, the multi-spectrum reflection will be used to identify the material, which in this case may be plastic or paper. In still other embodiments of the invention multiple scans will be performed at the same location and any change in the shape of the object will be used to determine whether the object is flexible or rigid. For example, in the example case of FIG. 2B, bag 230 may change shape between scans as in flaps in the wind. Once it is determined that bag 230 is a lightweight and flimsy object the appropriate response can be taken. For example, no action could be taken, or the location of the bag could be recorded so that it could be removed or investigated at a later time.

In the case of stone 232, the object detection system will note the size, shape and smooth surface. The shape and size of the object will be compared against a database and object identification performed. n some embodiments of the invention, object identification may be performed after or even concurrently with object detection. The object identification may incorporate artificial intelligence (AI) techniques. Additionally, in some embodiments of the invention the object detection system will note the level of reflectivity of the surface points. Additionally, when using a multi-spectrum lidar, the multi-spectrum reflection will be used to identify the material, which in this case would be natural rock. And in other embodiments of the invention, multiple scans will be performed at the same location and any difference in the shape of the object or obstacle will be used to determine whether stone 232 is rigid or flexible. In this case the object detection system should detect stone 232 is a solid and heavy object and then an appropriate response will be taken. For example, an automatic emergency response triggered, such as issuing a warning alarm or message, reducing the velocity or starting an emergency braking procedure to stop the train. If there is any obstacle blocking equipment or impact preparation materials available to the train, such items would be deployed.

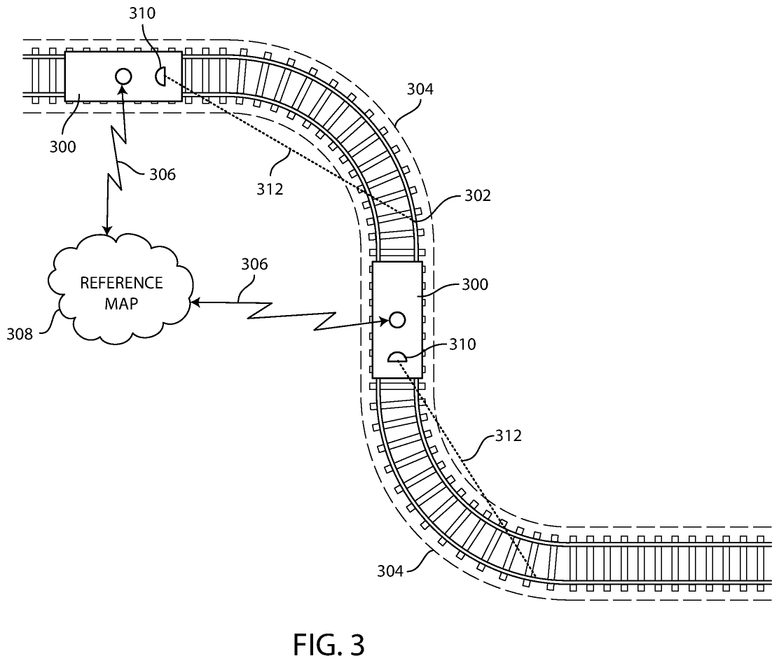

FIG. 3 is a top view diagram of a train and train tracks configured in accordance with one embodiment of the invention. In this configuration train 300 is travelling down track 302, which follows a known path associated with the regular route of train 300. The two instances of train 300 represent two different points in time as train 300 travels over track 302. Train 300 communicates via wireless link 306 with reference map 308, which is typically the same type of reference map as reference map 222 of FIG. 2. Still referring to FIG. 3, tunnel of travel 304 is a virtual zone following the path of track 302 and starting from the surface of the known path and having a predetermined height and width. Reference map contains the surface points associated with tunnel of travel 304 during a previous pass through that tunnel of travel.

During typical operation train 300 will use lidar 310 to transmit and receive laser pulses 312 into the area defined by tunnel of travel 304. For train 300 in the upper left portion of FIG. 3, this laser pulse is directed to the right of the current direction of travel of train 300 in anticipation of the upcoming curve in tracks 302. For train 300 located at the center of FIG. 3, lidar 300 continues to transmit laser pulse 312 to a location within tunnel of travel 304. In this instance, the curve of tunnel of travel 304 is such that laser pulse 312 is directed to the left of the current direction of travel in anticipation of the known path of tunnel of travel 304 and tracks 302. In general, the object detection system will use the known path of the tunnel of travel to focus the scanning function at some point ahead of the current direction of travel. but still within the tunnel of travel 304.

For both instances of train 300 shown in FIG. 3, the surface points detected with lidar 310 will be compared to the surface points of reference map 308 at the corresponding location within tunnel of travel 304. If differences are detected, then object detection will be performed as described herein. Additionally, in one embodiment of the invention reference map 308 will contain free space information. In this embodiment of the invention, if surface points are detected in locations that were designated as free space locations in reference map 308 then object detection is also performed.

The location, or locations, at which train 300 scans using lidar 310 may also depend on the speed of travel of train 300. For example, as the speed increases the scan may be performed further along the path of travel defined by tunnel of travel 304. Similarly, as the speed of train 300 decreases the scan may be performed closer along the path of travel defined by tunnel of travel 304 in order to maintain the most current scan possible given the speed train 300.

In some embodiments of the invention train 300 may store the scan data generated while passing through tunnel of travel 304 and then use that data to update reference map 308 at some point later in time. This could happen during the time train 300 is travelling, or it could be performed at a later time with possible comparison and combination with data from other passes through the tunnel of travel. The comparison and combination could include averaging or other transformation or combining of data sets. Additionally, if this is the first pass through tunnel of travel 304 using the scanning equipment, then the scan data may be used to create reference map 304.

In other embodiments of the invention train 300 will use multi-special lidar to perform surface scans. A system and method for performing material identification in accordance with some embodiments of the invention is described in international patent application PCT/EP2019/056842 filed on Mar. 19, 2019 entitled “METHOD AND SYSTEMS FOR IDENTIFYING MATERIAL COMPOSITION OF OBJECTS” incorporated herein by reference in its entirety. Another system for using multi-spectral lidar is described in co-pending U.S. patent application Ser. No. 16/675,016 filed on Nov. 5, 2019 and entitled “Adaptive Active Safety System Using Multi-spectral LIDAR” assigned to the assignee of the present invention and incorporated herein by reference in its entirety. Another description of a multi-spectrum lidar system that may be incorporated into some embodiments of the invention is described in co-pending U.S. patent application Ser. No. 16/735,452 filed on Jan. 6, 2020 and entitled “Multi-spectral LIDAR Object Tracking” assigned to the assignee of the present invention and incorporated herein by reference in its entirety.

In this embodiment laser pulse 312 is formed from two or more laser pulses of different frequency. The resulting change in relative intensity of the reflected pulses is used to assist in the identification of the material from which they reflected. This material identification can be combined with the shape and size of the new surface points detected to enhance the accuracy of the object detection as well as possible object identification. Once object detection or object identification have been performed then a more accurate response can also be taken.

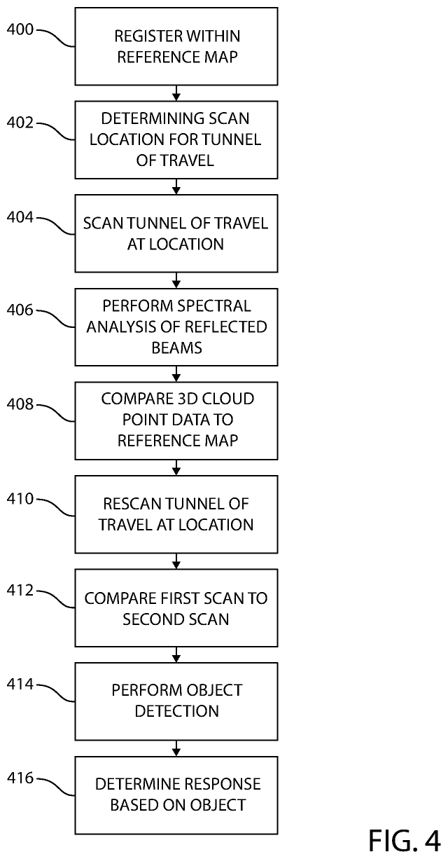

FIG. 4 is a flow chart illustrating the steps performed in accordance with one embodiment of the invention. At step 400 the train registers with the reference map containing the surface points for the tunnel of travel. This registration typically entails establishing the current location of the train within the tunnel of travel and downloading or preparing the segment of reference map for the portion of the tunnel of travel in front of the train. The segment of the reference map will normally include all the surrounding surface areas along the tunnel of travel detected and gathered during previous passages and scans.

At step 402 the scan location within the tunnel of travel is determined. This determination will typically take into account the velocity of the train, the curvature of the tunnel of travel (which can correspond to the curvature of the associated train tracks) as well as any objects obstructing the line-of-sight access to that location such as a hill or structure. In some embodiments of the invention the closest available line-of-sight location within the tunnel of travel will be used as the scan location if there is an obstacle between the train and the preferred location. For example, on a curved section of the track the scan may have to performed on a closer segment of the tunnel of travel than would otherwise be used.

At step 404 a scan of the tunnel of travel is performed at the determined location. At step 406 a spectral analysis is performed on the reflected laser pulses received by the lidar. This is particularly useful for embodiments of the invention where multi-spectrum lidar is used. This multi-spectrum analysis may be used to identify the material from which the reflections originate.

At step 408 the 3D point cloud data from the scan is compared with the surface data from the reference map at the corresponding location (or position). If the comparison results in a set of surface points that were previously not in the reference map an object set is created using these new points. Connected 3D points may be grouped into objects and the size and shape of these objects determined. The size and shape information can be combined with the identification of any materials as described in the previous step.

Additionally, surface points that were part of the reference map, but which were not detected by the scan, may be grouped together into gaps, voids or holes. These voids may also be used as part of any response performed later in this process.

In one embodiment of the invention, the reference map includes free space locations and the 3D point cloud from the scan is compared with the free space location in the reference map. The object set may then be created from points where free space locations have changed to occupied locations.

In some embodiments of the invention a rescan of the tunnel of travel at the same location may be performed at step 410. This rescan will provide additional data that will increase the reliability of the surface information and may also aid in object detection. At step 412 the changes between the first and second scan within tunnel is determined. If changes are detected, this is also used in performing object detection. In particular, where significant changes are detected this may indicate a lack of rigidity of those objects and this can be taken into account when performing object detection or identification. For example, an object might be identified as a paper or plastic bag for which no response is required.

At step 414 object detection and identification is performed. Object detection is preferably performed using some or all of the information gathered or generated in the previous steps. At step 416 the response to the object detection will be determined based on the nature of the particular object detected. Possible responses include sounding alarms, changing the velocity of the train, activating lights, notifying the conductor or sending messages for response by other systems.

In some embodiments of the invention, the data from the scans performed during each pass by train may be used to update the reference map. This will assist in maintaining an accurate reference map and will allow small changes in the irregular surface to be taken into account such as rocks moving or erosion.

In one embodiment of the invention, the reference map is initially generated during a first pass of the lidar through the tunnel of travel. The surfaces detected by the scans performed during this first pass can be stored and then assembled into a reference map that can be used during later passes. The reference map can be supplemented with the scans performed during later passes as well including passes in which the existing reference map is used to perform object identification. The reference map may also be supplemented with free space information.

It should be understood that while the invention is described in the context of a train travelling over train tracks the invention may be incorporated into many other environments including, for example buses or elevators. where regular travel over a known path is performed. And, as mentioned elsewhere in this application, object detection can also include detection of voids or gaps, which present their own dangers in a moving system such as a train. Also, while the invention is described in the context of using a lidar based surface detection system, the use of other imaging systems is also consistent with some embodiments of the invention.

Thus, a system and method for performing object detection and identification has been described. While the invention has been set forth in the context of various embodiments, it should be understood that these embodiments do not limit the scope or breadth of the invention. Rather, the scope and breadth of the invention (or inventions) described herein is set forth more particularly in the claims provided herein or ultimately set forth in any final issued patent or patents.

1-20. (canceled)

21. A method for controlling the operation of a train that travels along a route, said method comprising the steps of:
generating a reference map during a first pass along a route, wherein said route is defined by railroad tracks on which the train regularly travels, said reference map containing both occupied points and unoccupied points.
registering said train at a location in said reference map during a second pass over said tracks, wherein said second pass is performed by said train;
comparing 3D point cloud data generated during said second pass with said reference map.
scanning said path at a predetermined distance ahead of a current location of said train along the path of said tracks during said second pass;
comparing said unoccupied points in said reference map with 3D point cloud data generated during said scanning step;
performing object detection using occupied points from said 3D point cloud data that were said unoccupied points in said reference map, thereby creating a detected object having a shape, wherein
said 3D point cloud data is generated using a multi-spectrum light detection and ranging (lidar) and a reflected spectrum is used to perform material identification for said detected object, and further wherein said material identification and said shape are used to perform object identification for on said detected object.

22. The method of claim 21 wherein said generating step is comprised of the steps of:
a. scanning said path using a 3D sensor thereby generating scan data;
b. storing said scan data in said reference map.

23. The method of claim 21 wherein said generating step is comprised of the steps of:
a. moving along said track;
b. scanning a virtual tunnel over said track using a 3D sensor to generate 3D points;
c. storing said 3D points in said reference map.

24. The method of claim 21 wherein said track is comprised of two rails and said train rides on said two rails.

25. The method of claim 21 wherein said track in comprised of a single rail and said train rides on ground-based wheels and said train is guided by said track.

26. A system for operating a train network, said system including a method for detecting objects in front of a train moving across a path over a track comprising the steps of:
generating 3D cloud data for a tunnel of travel above said route using a lidar sensor during an initial pass over said track using a forerunner train;
comparing said 3D point cloud data to a baseline reference map created during a previous pass along said path by a lidar based system, wherein said lidar performs surface detection above said track and wherein said surface detection is performed a predetermined distance in front of the vehicle in an area above said track and said baseline reference map contains occupied points and free space locations associated with said tunnel of travel above said track, and wherein said lidar is multi-spectrum lidar and said 3D cloud data includes spectrum reflection information for 3D points;
performing object detection based on a difference between said 3D point cloud data and said baseline reference map, thereby creating a detected object, wherein said object detection is performed using 3D points that were previously said free space locations;
performing material identification using said spectrum reflection information;
performing object identification on said detected object using said material identification; and
determining a response to said object identification based on said object identification.

27. The method as set forth in claim 26 further comprising the steps of:
determining a shape of said object based on said difference between said #D point cloud data and said baseline reference map;
performing object identification on said detected object using said material identification and said shape.

28. The method of claim 26 wherein said generating step is comprised of the steps of:
a. scanning said path using a 3D sensor thereby generating scan data;
b. storing said scan data in said reference map.

29. The method of claim 26 wherein said generating step is comprised of the steps of:
a. moving along said track;
b. scanning a virtual tunnel over said track using a 3D sensor to generate 3D points;
c. storing said 3D points in said reference map.

30. The method of claim 26 wherein said track is comprised of two rails and said train rides on said two rails.

31. The method of claim 26 wherein said track in comprised of a single rail and said train rides on ground-based wheels and said train is guided by said track.

32. A train for travelling over a track, said train configured to identify and respond to objects on a track, said train comprising:
a lidar for scanning a physical environment along a path and for generating 3D point cloud data corresponding to physical surfaces in said physical environment, wherein said 3D point cloud data is generated using a multi-spectrum lidar;
microprocessor for performing operations in response to machine readable instructions;
one or more non-transitory computer readable media for storing machine readable instructions for performing the following steps:
registering said train at a location in a reference map generating during a first pass along said track, said reference map containing both free space points and occupied locations;
scanning along said track at a predetermined distance in front of a current location of said vehicle;
comparing free space points in said reference map with 3D point cloud data generated during said scanning step;
performing object detection using occupied points from said 3D point cloud data that were free space points in said reference map;
performing material identification using a reflected spectrum from said multi-spectrum lidar; and
performing object identification on said detected object using said material identification.

33. The train of claim 32 further comprising:
3D sensor for scanning said path, and wherein said memory is for storing said reference map.

34. The train of claim 32 wherein said reference map was generated by moving along said track, scanning said path using a 3D sensor to generate 3D points, and storing said 3D points in said reference map.
